(19) United States
(12) Patent Application Publication
(10) Pub. No.: US 2010/0034160 A1
(43) Pub. Date: Feb. 11, 2010

(54) UPDATING FREQUENCY PRIORITY LISTS IN WIRELESS COMMUNICATIONS

(75) Inventors: Rajat Prakash, La Jolla, CA (US); Masato Kitazoe, Tokyo (JP); Nathan E. Tenny, Poway, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/510,495

(22) Filed: Jul. 28, 2009

Related U.S. Application Data
(60) Provisional application No. 61/087,552, filed on Aug. 8, 2008.

(51) Int. Cl. H04W 72/04

(52) U.S. Cl. 370/329

(57) ABSTRACT

Systems and methodologies are described that facilitate communicating frequency priority lists to wireless devices during active mode communication. The lists can be communicated according to a timer, as new lists (or updates thereto) are generated or obtained, and/or the like. In this regard, devices can receive frequency priority lists before connection to an access point is released or lost. Upon connection release or link failure, devices can use the frequency priority list to monitor frequencies for receiving paging signals. In addition, the frequency priority lists can include layer types corresponding to the frequencies that specify types of access points related to the frequencies. Certain frequencies can be avoided or monitored for paging signals according to the layer types.

### CLAIM OF PRIORITY UNDER 35 U.S.C. §119

This application claims the benefit of U.S. Provisional Application Ser. No. 61/087,552, filed Aug. 8, 2008, and entitled “METHOD AND APPARATUS FOR UPDATING FREQUENCY PRIORITY LISTS,” assigned to the assignee hereof, and the entirety of which is incorporated herein by reference.

### BACKGROUND

I. Field

The present disclosure relates generally to wireless communications and more specifically to frequency priority lists.

II. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), etc.

Generally, wireless multiple-access communication systems may simultaneously support communication for multiple wireless devices. Each wireless device may communicate with one or more access points (e.g., base stations, femtocells, picocells, relay nodes, and/or the like) via transmissions on forward and reverse links. The forward link (or downlink) refers to the communication link from access points to wireless devices, and the reverse link (or uplink) refers to the communication link from wireless devices to access points. Further, communications between wireless devices and access points may be established via single-input single-output (SISO) systems, multiple-input single-output (MISO) systems, multiple-input multiple-output (MIMO) systems, and so forth. In addition, wireless devices can communicate with other wireless devices (and/or access points with other access points) in peer-to-peer wireless network configurations.

Wireless devices can operate in idle and active modes, for example, where an idle mode wireless device communicates with an access point at a minimal level to stay connected, but does not necessarily receive access to the wireless network. In 3GPP LTE, for example, upon releasing active connection from an access point and moving to idle mode, a wireless device can receive a frequency priority list specific to the wireless device from the access point. The frequency priority list indicates frequencies over which the wireless device can receive paging messages from the wireless network requesting the wireless device switch to active mode, and establish connection with an access point. In addition, the list can be prioritized to cause devices to evaluate some frequencies before or instead of others; the prioritization can be based on signal strength, in one example. Since frequency priority lists are sent at connection release, wireless devices that experience link failure may not be provisioned with a current list.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

In accordance with one or more embodiments and corresponding disclosure thereof, various aspects are described in connection with facilitating transmitting frequency priority lists and related information to wireless devices in an active communication mode to ensure the wireless devices have updated priority lists. In one example, the lists can be transmitted using a radio resource control (RRC) layer message. This can be a new message or an existing message, such as a connection reconfiguration message (e.g., RRCConnectionReconfiguration). In this regard, a wireless device can receive updated lists while connected to the access point in active mode rather than having to wait for connection release. Additionally, in one example, a layer type can be added to specific frequencies in the frequency priority list to indicate frequencies associated with types of cells, such as closed subscriber group (CSG), and/or the like.

According to related aspects, a method is provided that includes establishing active mode communications with an access point and receiving a frequency priority list from the access point during the active mode communications. The method also includes storing the frequency priority list for subsequent use in determining one or more frequencies for receiving paging signals.

Another aspect relates to a wireless communications apparatus. The wireless communications apparatus can include at least one processor configured to communicate with an access point in an active mode and receive a frequency priority list from the access point while communicating in the active mode. The at least one processor is further configured to store the frequency priority list for subsequent utilization in determining one or more frequencies for receiving paging signals. The wireless communications apparatus also comprises a memory coupled to the at least one processor.

Yet another aspect relates to an apparatus. The apparatus includes means for communicating with an access point in an active mode and means for receiving a frequency priority list from the access point in the active mode and storing the list for subsequent utilization in an idle communication mode.

Still another aspect relates to a computer program product, which can have a computer-readable medium including code for causing at least one computer to establish active mode communications with an access point. The computer-readable medium can also comprise code for causing the at least one computer to receive a frequency priority list from the access point during the active mode communications and code for causing the at least one computer to store the frequency priority list for subsequent use in determining one or more frequencies for receiving paging signals.

Moreover, an additional aspect relates to an apparatus including a communication mode component that communicates with an access point in an active mode. The apparatus can further include a frequency priority list component that receives a frequency priority list from the access point in the active mode and stores the list for subsequent utilization in an idle communication mode.

According to further aspects, a method is provided that includes establishing a connection with a mobile device communicating in an active mode and receiving a frequency priority list related to the mobile device. The method additionally includes transmitting the frequency priority list to the mobile device in a connection reconfiguration message.

Another aspect relates to a wireless communications apparatus. The wireless communications apparatus can include at least one processor configured to communicate with a mobile device operating in an active mode. The at least one processor is further configured to obtain a frequency priority list related to the mobile device and transmit the frequency priority list to the mobile device in a connection reconfiguration message. The wireless communications apparatus also comprises a memory coupled to the at least one processor.

Yet another aspect relates to an apparatus. The apparatus includes means for establishing active mode communication with a mobile device and means for obtaining a frequency priority list related to the mobile device. The apparatus also includes means for transmitting the frequency priority list to the mobile device in a connection reconfiguration message.

Still another aspect relates to a computer program product, which can have a computer-readable medium including code for causing at least one computer to establish a connection with a mobile device communicating in an active mode. The computer-readable medium can also comprise code for causing the at least one computer to receive a frequency priority list related to the mobile device and code for causing the at least one computer to transmit the frequency priority list to the mobile device in a connection reconfiguration message.

Moreover, an additional aspect relates to an apparatus including a RRC connection establishing component that initializes active mode communication with a mobile device and a frequency priority list managing component that obtains a frequency priority list related to the mobile device. The apparatus can further include a frequency priority list provisioning component that transmits the frequency priority list to the mobile device in a connection reconfiguration message.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed, and the described embodiments are intended to include all such aspects and their equivalents.

### BRIEF DESCRIPTION OF THE DRAWINGS

FIG. 1 is a block diagram of a system for communicating frequency priority lists in an active communication mode.

FIG. 2 is an illustration of an example communications apparatus for employment within a wireless communications environment.

FIG. 3 illustrates an example wireless communication network that effectuates providing frequency priority lists to devices in active communication modes.

FIG. 4 illustrates an example wireless communication system that communicates with an access point and receives a frequency priority list.

FIG. 5 is a flow diagram of an example methodology that receives and stores a frequency priority list received in an active communication mode.

FIG. 6 is a flow diagram of an example methodology that utilizes layer types in a frequency priority list when monitoring frequencies for paging signals.

FIG. 7 is a flow diagram of an example methodology that provides a frequency priority list to devices in active communications mode.

FIG. 8 is a block diagram of an example apparatus that receives frequency priority lists while communicating in active mode and utilizes the list when in an idle communications mode.

FIG. 9 is a block diagram of an example apparatus that facilitates transmitting frequency priority lists to mobile devices communicating in active mode.

FIGS. 10-11 are block diagrams of example wireless communication devices that can be utilized to implement various aspects of the functionality described herein.

FIG. 12 illustrates an example wireless multiple-access communication system in accordance with various aspects set forth herein.

FIG. 13 illustrates an example wireless communication system in accordance with various aspects set forth herein.

FIG. 14 illustrates an example communication system in accordance with aspects described herein.

FIG. 15 illustrates an example wireless coverage map in accordance with various aspects set forth herein.

FIG. 16 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Evolved Node B (eNB)) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

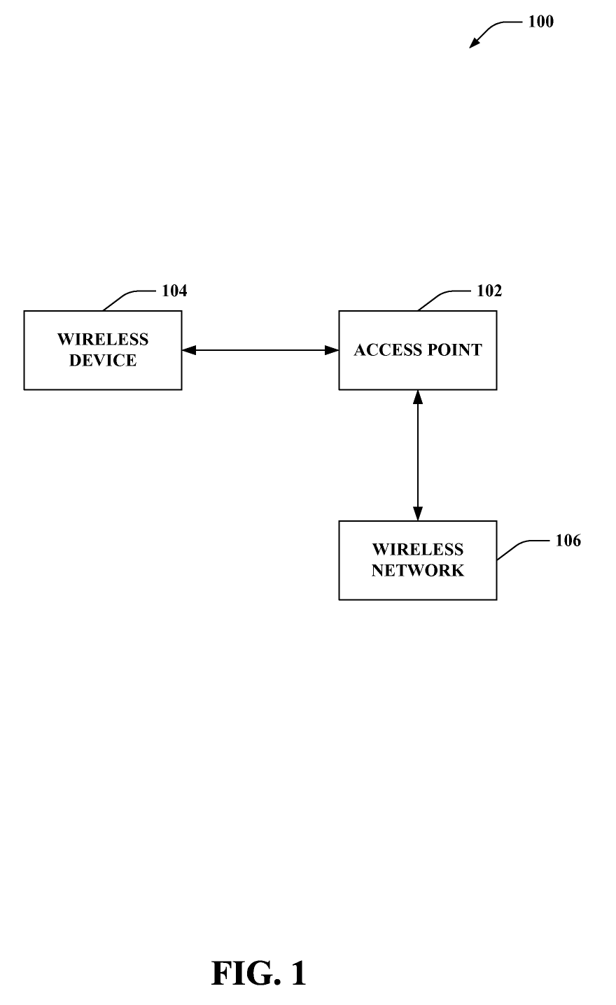

Referring now to the drawings, FIG. 1 illustrates an example wireless network 100 that facilitates communicating frequency priority lists to one or more devices. An access point 102 is provided that communicates with a wireless device 104 to provide access to a wireless network 106. Access point 102 can be a macrocell access point, femtocell or picocell access point, disparate wireless device, portions thereof, or substantially any device that provides access to the wireless network 106. In addition, wireless device 104 can be a mobile device, a portion thereof, or substantially any device that receives access to the wireless network 106.

According to an example, the wireless device 104 can communicate with the access point 102 in an idle or active mode. In an idle mode, for example, the wireless device 104 can listen for paging signals from the access point 102 or other devices indicating that the wireless device 104 switch to active mode and communicate with the access point 102 or one or more disparate access points. When communicating in an active mode, access point 102 can transmit frequency priority lists to the wireless device 104, which are lists of frequencies to monitor for paging signals prioritized based on one or more criteria, such as signal strength. For example, the access point 102 can transmit the lists according to a timer, when policies or other parameters affecting the list change for the wireless device 104 or network, and/or the like. The wireless device 104 can store the list for subsequent usage when active connection with the access point 102 is terminated. In this regard, the wireless device 104 can maintain an updated frequency priority list without waiting for connection release. In addition, if the link fails between the wireless device 104 and access point 102, wireless device 104 can utilize a stored frequency priority list to listen for paging signals in idle mode.

In an example, access point 102 can additionally indicate a layer type for the frequencies in the list, such that the wireless device 104 can use the layer type to differentiate between access point types that utilize the frequencies, such as access points implementing closed subscriber group (CSG) cells. Wireless device 104 may wish to avoid CSG cells or receive signals only from CSG cells. In either case, wireless device 104 can tune to frequencies according to the layer type indicated in the list (as well as priorities for the frequencies). In one example, the access point 102 can receive the layer type information for indication in the priority list by listening to signals from various access points, a specification, hardcoding, a disparate component in the wireless network 106, configuration, and/or the like. In another example, access point 102 can receive the frequency priority list, and/or updates thereto, from wireless network 106.

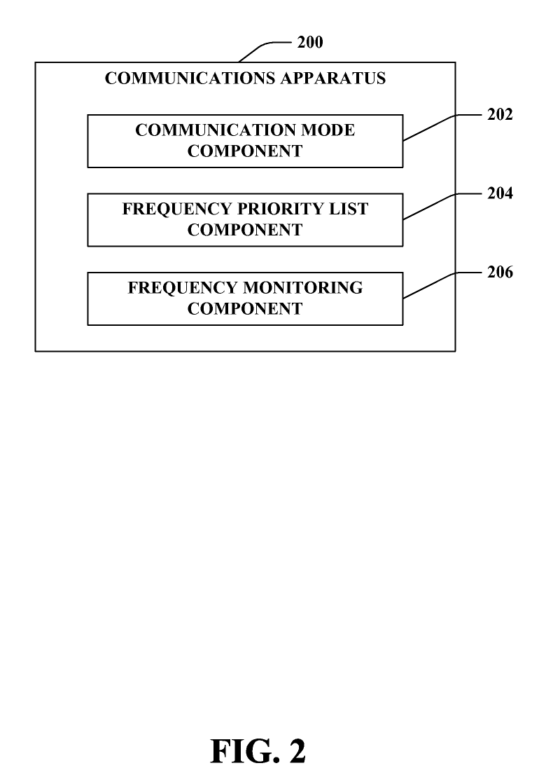

Referring next to FIG. 2, a communications apparatus 200 that can participate in a wireless communications network is illustrated. The communications apparatus 200 can be a mobile device, a portion thereof, or substantially any device that can receive access to a wireless network. The communications apparatus 200 can include a communication mode component 202 that can alternate between idle and active communication modes in a wireless network, a frequency priority list component 204 that can receive and/or store a frequency priority list or updates thereto, and a frequency monitoring component 206 that can analyze one or more frequencies for signals related to one or more access points (not shown).

According to an example, the communication mode component 202 can select a mode for the communications apparatus 200 to communicate with another device. As described, for example, the communication mode component 202 can select idle or active mode communications. When in idle mode, the frequency monitoring component 206 can evaluate frequencies to receive paging signals from one or more network devices. When a paging signal is received that indicates communications apparatus 200 should connect to the wireless network, for example, the communication mode component 202 can begin switching to active mode communications, which can occur based on access information obtained from the one or more network devices. Once connected to a network device, the frequency priority list component 204 can obtain frequency priority lists from the network device throughout the active mode communications. The frequency priority list component 204 can receive the lists in radio resource control (RRC) layer messages during active mode connection. For example, the lists can be received in newly defined messages, reconfiguration messages (e.g., RRCConnectionReconfiguration), and/or the like, such that the lists are received before connection release (e.g., RRCConnectionRelease at the RRC layer).

As described, the frequency priority lists can be obtained upon modification of parameters related to the list, according to a scheduled, etc. In another example, the frequency priority list component 204 can request an updated list from a network device. In addition, the frequency priority list component 204 can store the received lists for subsequent use in monitoring frequencies for paging. As described, after connection is lost or released, the frequency monitoring component 206 can evaluate frequencies in the list for paging signals according to indicated priority. Additionally, frequency priority list component 204 can receive frequency priority lists that comprise layer type indicators related to access point type. Thus, for example, frequency monitoring component 206 can avoid or explicitly evaluate frequencies related to certain types of access points. Moreover, for example, the frequency priority list component 204 can receive updates for a stored frequency priority list additionally or alternatively to the full frequency priority list.

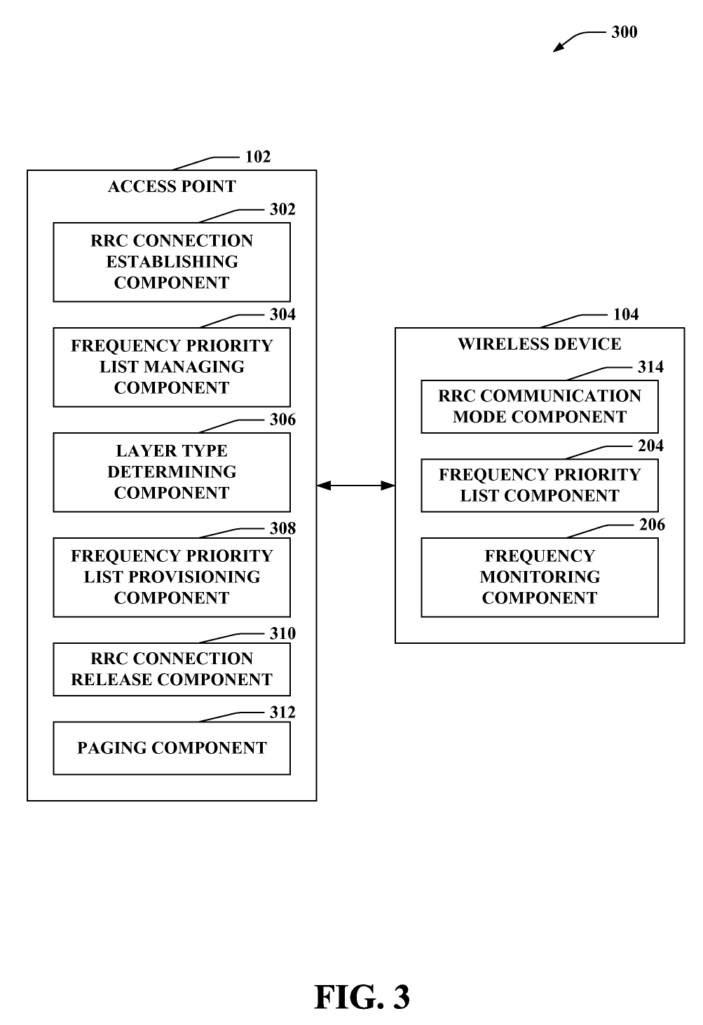

Now referring to FIG. 3, illustrated is a wireless communications system 300 that facilitates providing frequency priority lists in active communications. System 300 includes an access point 102, which, as described, can be substantially any type of base station or mobile device (including not only independently powered devices, but also modems, for example) that provides wireless network access, and/or portion thereof. In addition, wireless device 104 can be a mobile device or other device that receives wireless network access. Moreover, system 300 can be a MIMO system and/or can conform to one or more wireless network system specifications (e.g., EV-DO, 3GPP, 3GPP2, 3GPP LTE, WiMAX, etc.).

Access point 102 can comprise an RRC connection establishing component 302 that performs RRC connection setup with devices in a wireless network, a frequency priority list managing component 304 that maintains one or more frequency priority lists related to certain wireless devices, a layer type determining component 306 that can receive layer types related to paging frequencies, a frequency priority list provisioning component 308 that can provide frequency priority lists to one or more wireless devices, an RRC connection release component 310 that can terminate an RRC connection with a wireless device, and a paging component 312 that can transmit a page requesting a wireless device to switch from idle to active mode. Wireless device 104 can comprise an RRC communication mode component 314 that can implement one or more communication modes for the wireless device 104, a frequency priority list component 204 that can receive and store a frequency priority list, and a frequency monitoring component 206 that can analyze one or more frequencies for paging signals.

According to an example, RRC communication mode component 202 can be in an idle mode, and the frequency monitoring component 206 can listen over one or more frequencies for a paging signal. Paging component 312, for example, can send a paging signal to the wireless device 104 causing the RRC communication mode component 314 to switch to an active mode and send an RRC connection setup request to the access point 102. RRC connection establishing component 302 can initialize an RRC connection with the wireless device 104. It is to be appreciated, for example, that this can include verifying parameters with upstream network components (not shown) to authenticate/authorize the wireless device 104.

Frequency priority list managing component 304 can establish and/or maintain a frequency priority list related to the wireless device 104. In one example, the list can be received from a wireless network (e.g., from a mobility management entity (MME)), generated by the frequency priority list managing component 304 based on neighboring signals, received from a configuration, network specification, hardcoding, and/or the like. The frequency priority list can be prioritized based at least in part on signal strength of access points utilizing the frequency, access point type, and/or the like. In addition, for example, the layer type determining component 306 can receive information regarding access point types utilizing the frequencies and can include a corresponding layer type in the frequency priority list. In another example, the layer types can be received from the wireless network.

In addition, frequency priority list managing component 304 and/or layer type determining component 306 can receive updates related to frequencies in the list, such as reprioritization, and/or the like, from the wireless network, by evaluating signals on neighboring frequencies, via modified configuration, etc., and can update the frequency priority list. Upon receiving updates, the frequency priority list provisioning component 308 can provide the updated list (e.g., the full list or update packets) to the wireless device 104 during active mode communications. In one example, the frequency priority list provisioning component 308 can transmit the list (or updates) in an RRC message, which can be a newly defined message, reconfiguration message, and/or the like, as described. In addition, frequency priority list provisioning component 308 can send frequency priority lists to the wireless device 104 according to a timer, at certain points during communication, and/or the like such that the wireless device 104 can receive one or more lists before connection release.

The frequency priority list component 204 can receive and store the list for later use in evaluating frequencies for paging signals. For example, RRC connection release component 310 can release the RRC connection with the wireless device, which can cause the RRC communication mode component 314 to switch to idle mode. In another example, the link between wireless device 104 and access point 102 can fail. In either case, frequency priority list component 204 can have been provisioned with a current list, as described above. Frequency monitoring component 206 can listen over frequencies in the list for paging signals. As described, the frequency priority list can include layer types such that frequency monitoring component 206 can avoid evaluating certain frequencies based on the type, such as CSG cell frequencies where wireless device 104 does not support communication in a CSG cell. In another example, the frequency monitoring component 206 can prefer access point types in monitoring frequencies based on the layer types.

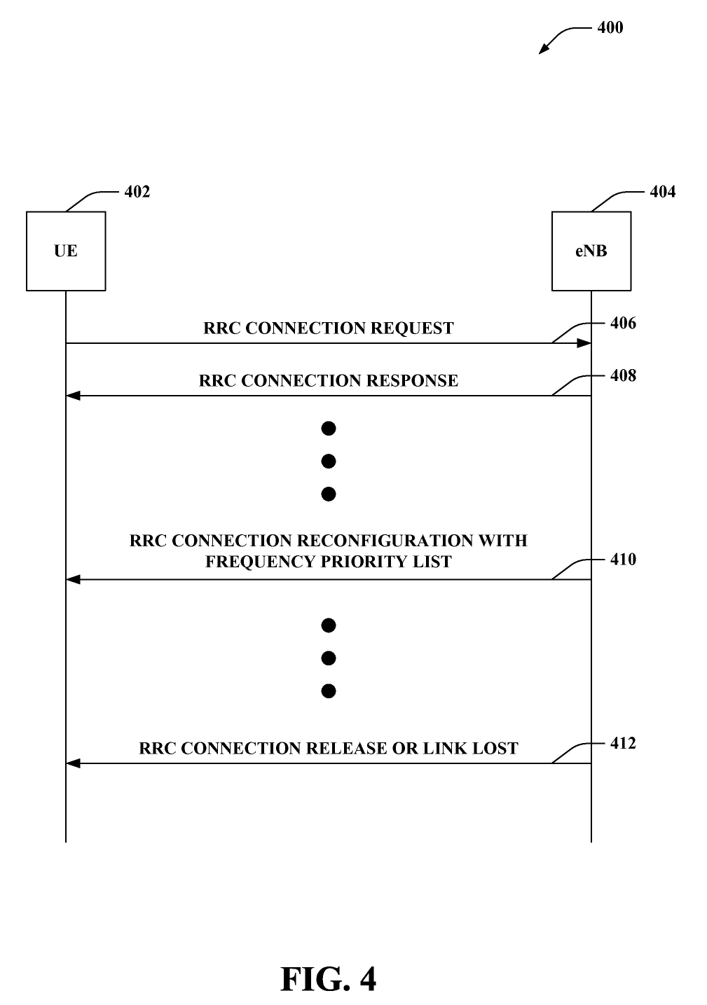

Referring to FIG. 4, an example wireless communications system 400 is depicted that facilitates transmitting frequency priority lists during active mode communications. System 400 includes a UE 402, which can be substantially any wireless device, communicating with an eNB 404, which can be substantially any type of access point (and/or upstream network node) providing wireless network access to the UE 402. As shown, UE 402 can send an RRC connection request 406 to eNB 404 to initialize active mode communications therewith. In one example, the RRC connection request 406 can be transmitted based at least in part on receiving signaling from the eNB 404 or other network component to switch from an idle to an active mode.

eNB 404 can receive the RRC connection request and verify the request, which can entail consulting one or more upstream network components, such as an MME, policy and charging resource function (PCRF), etc. (not shown), to authenticate or authorize the UE 402 for wireless network access. eNB 404 can subsequently forward an RRC connection response 408 to the UE 402, which can indicate status of the RRC connection request; the status is successful in this example. UE 402 and eNB 404 can continue to communicate in active mode, and the eNB 404 can transmit an RRC connection reconfiguration message including a frequency priority list 410 to the UE 402. The UE 402 can receive the frequency priority list in the message and store the list for subsequent utilization.

As described, the frequency priority list can be sent in the reconfiguration message according to a timer, upon eNB 404 receiving policy or parameter changes related to the UE 402 or the frequency priority list, and/or the like. Moreover, in this regard, it is to be appreciated that the eNB 404 can transmit multiple frequency priority lists (or updates thereto) to the UE 402 throughout communications. Sending the list in this manner allows the UE 402 to maintain a current list to utilize in the case of connection release or link lost. eNB 404 can transmit an RRC connection release message or the link can be lost 412 with the UE 402. In either case, the UE 402 can utilize the last received frequency priority list to scan high priority frequencies for paging signals, as described. In addition, as described, the frequency priority list can comprise a layer type indicator that specifies access point types related to the frequencies. In this regard, the UE 402 can avoid or evaluate certain frequencies additionally based on the access point type (e.g., UE 402 can avoid or explicitly evaluate frequencies for CSG cells depending on UE 402 implementation).

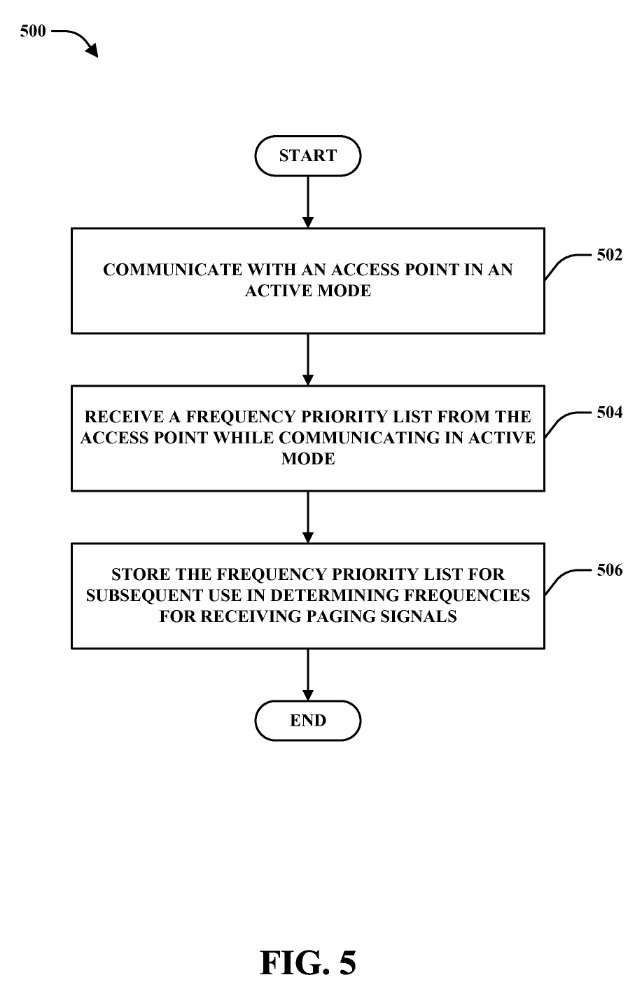

Referring now to FIGS. 5-7, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Referring to FIG. 5, illustrated is a methodology 500 for receiving frequency priority lists during active mode communications. At 502, an access point can be communicated with in an active mode. As described, in certain communication networks (such as 3GPP LTE), active and idle mode communications are possible where, for example, active mode includes establishing connection and communicating with an access point. At 504, a frequency priority list can be received from the access point while communicating in active mode. In this regard, a frequency priority list can be received before connection to the access point is released or lost. At 506, the frequency priority list can be stored for subsequent use in determining frequencies for receiving paging signals. As described, for example, the frequency priority list can additionally include layer type indicators that specify frequencies related to given types of access points.

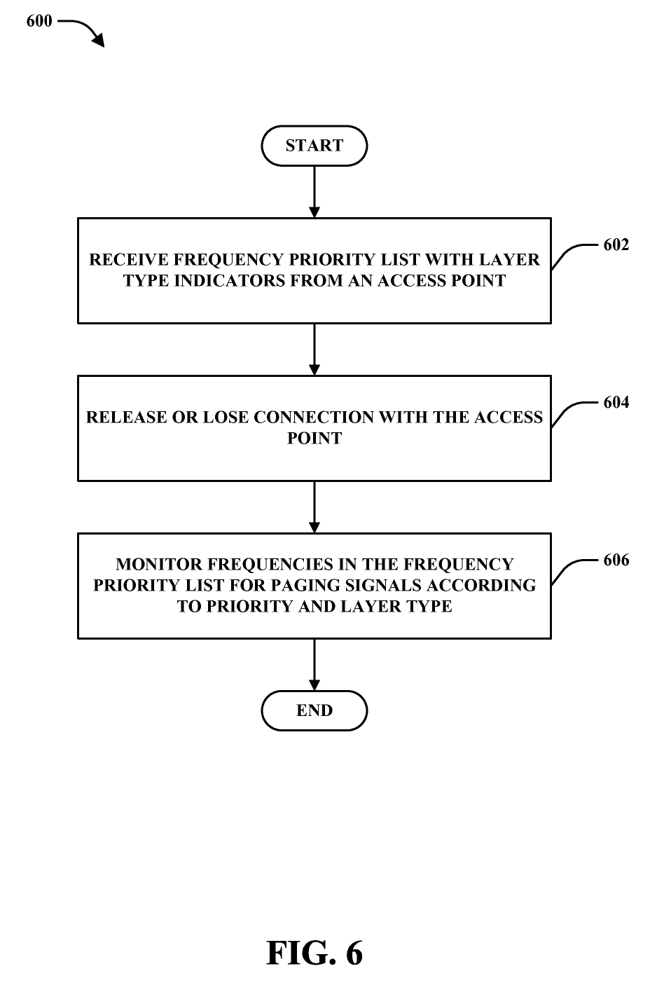

With reference to FIG. 6, illustrated is a methodology 600 for utilizing frequency priority lists comprising layer type indicators. At 602, a frequency priority list with layer type indicators can be received from an access point. As described, the layer type indicators can associate frequencies in the list with given types of access points. For example, CSG cell frequencies can be identified using a layer type so that such cells can be avoided or preferred in monitoring for paging signals. At 604, connection with the access point can be released or lost. In this regard, disconnection can be planned or spontaneous; in either case, a frequency priority list can be received before this occurrence, during active mode communications, to ensure an updated list is maintained. At 606, frequencies in the frequency priority list can be monitored for paging signals according to priority and layer type. Thus, as described, certain access point type frequencies can be avoided or expressly monitored for paging signals.

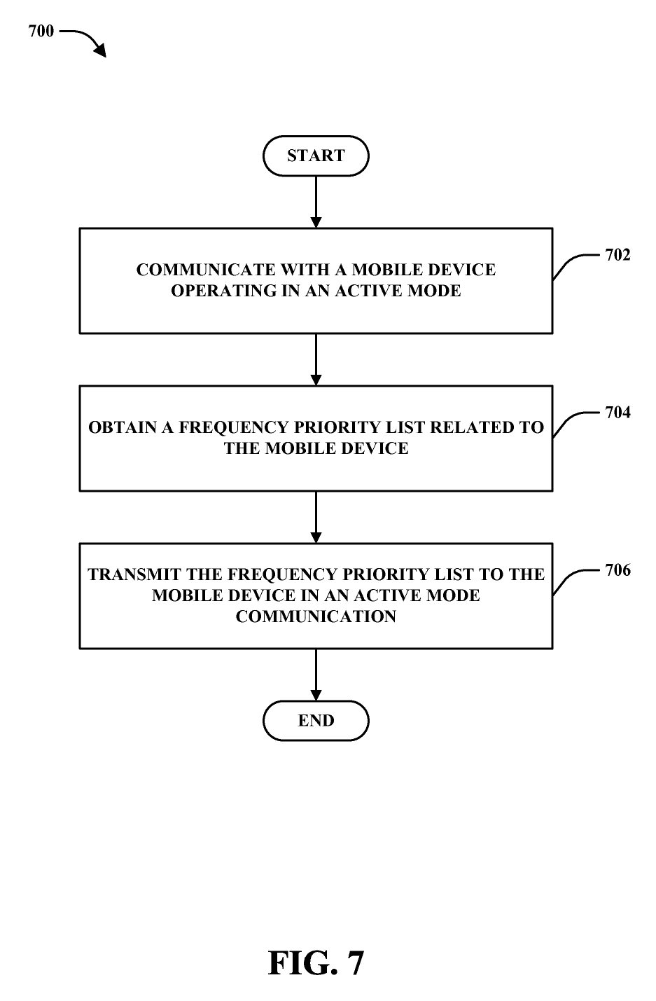

Turning to FIG. 7, a methodology 700 is illustrated that facilitates providing frequency priority lists to mobile device during active mode communications. At 702, a mobile device operating in an active mode can be communicated with. As described, such devices can operate in idle and active modes in certain network configurations, and switching to active mode can be caused by transmitting a paging signal to the device. At 704, a frequency priority list related to the mobile device can be obtained. As described, the frequency priority list can be received from an upstream network component (e.g., MME), generated based on received or obtained information regarding surrounding access points, received from a configuration or according to a network specification, and/or the like. At 706, the frequency priority list can be transmitted to the mobile device in active mode communications. This can be according to a timer, based on obtaining the frequency priority list, and/or the like. In any case, the device is provisioned with a frequency priority list before connection release or failure, as described.

It will be appreciated that, in accordance with one or more aspects described herein, inferences can be made regarding generating a frequency priority list, determining and indicating layer types within the list, transmitting an updated list to a mobile device, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

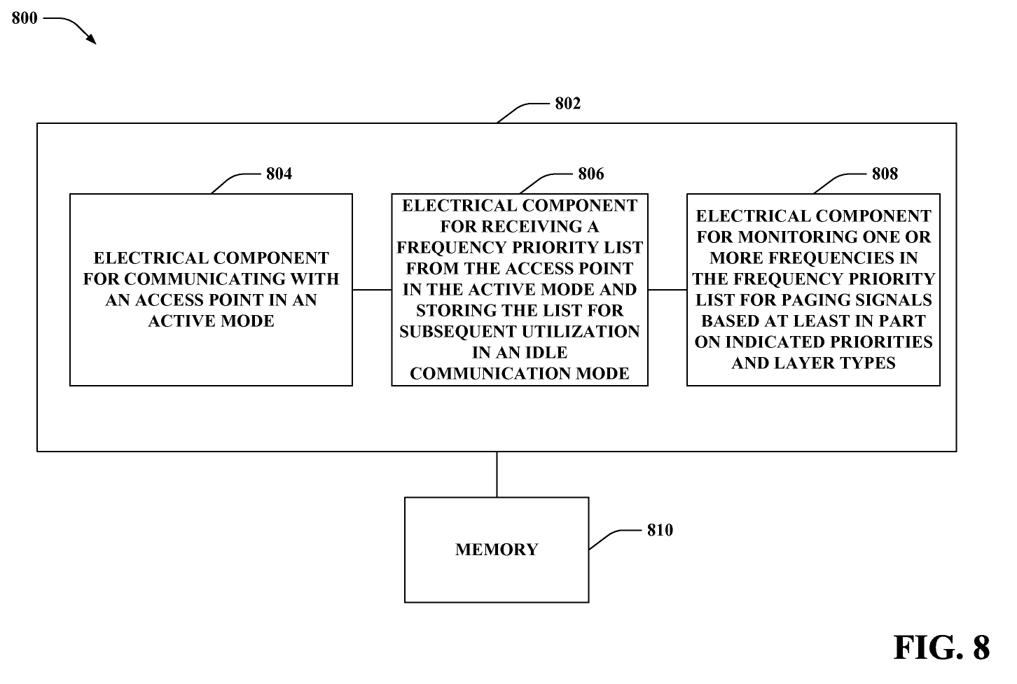

With reference to FIG. 8, illustrated is a system 800 that receives frequency priority lists during active mode communications. For example, system 800 can reside at least partially within a base station, mobile device, or another device that provides access to a wireless network. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for communicating with an access point in an active mode 804. For example, as described, this can include establishing connection with the access point and receiving access to a wireless network therefrom. Further, logical grouping 802 can comprise an electrical component for receiving a frequency priority list from the access point in the active mode and storing the list for subsequent utilization in an idle communication mode 806. Thus, the list can be received before connection release or link failure, as described.

When the connection is released or upon link failure, electrical component 804 can switch to idle mode communications where it monitors frequencies for paging signals. In this regard, logical grouping 802 can include an electrical component for monitoring one or more frequencies in the frequency priority list for paging signals based at least in part on indicted priorities and layer types 808. As described, the frequency priority list can comprise layer type indicators that specify access point types corresponding to frequencies in the list. Thus, for example, electrical component 808 can avoid frequencies related to certain types of access points (e.g., CSG cell access points), or include such types in the monitoring. Additionally, system 800 can include a memory 810 that retains instructions for executing functions associated with electrical components 804, 806, and 808. While shown as being external to memory 810, it is to be understood that one or more of electrical components 804, 806, and 808 can exist within memory 810.

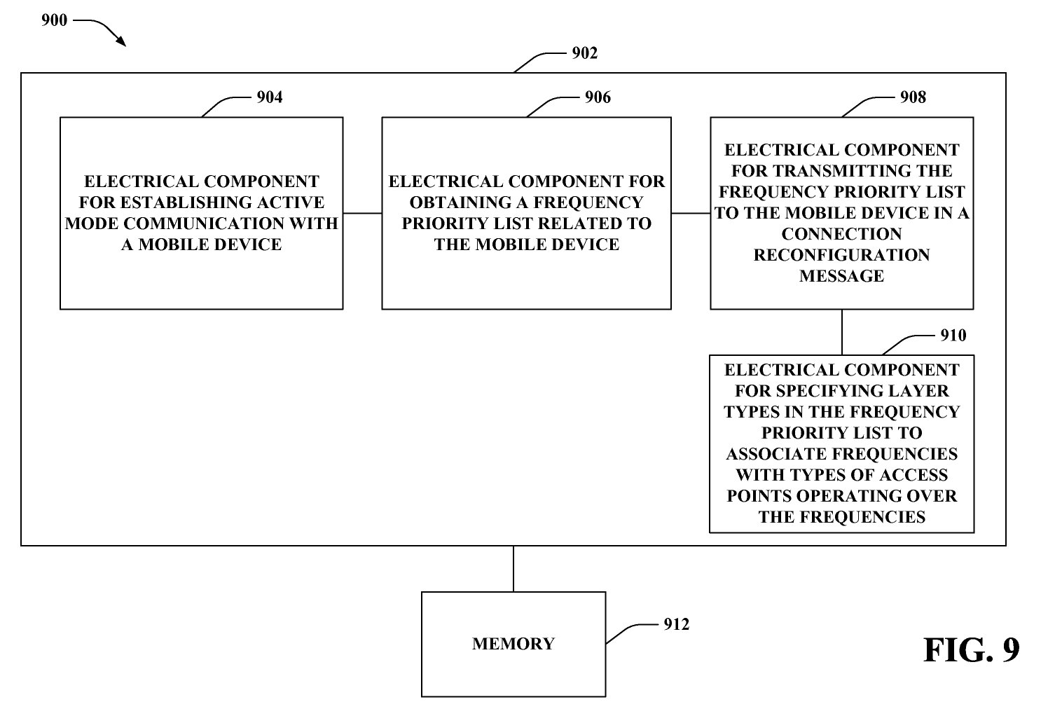

With reference to FIG. 9, illustrated is a system 900 that provides frequency priority lists to devices in active communication modes. For example, system 900 can reside at least partially within a base station, mobile device, etc. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for establishing active mode communication with a mobile device 904. This can include, for example, an RRC connection establishment procedure, as described previously. Further, logical grouping 902 can comprise an electrical component for obtaining a frequency priority list related to the mobile device 906. As described, this can be obtained from a disparate network component, such as an MME, generated from received or monitored parameters of disparate access points, obtained from a configuration or network specification, and/or the like.

Moreover, logical grouping 902 includes an electrical component for transmitting the frequency priority list to the mobile device in a connection reconfiguration message 908. This can be an RRC message, as described, for transmitting modified connection parameters to the mobile device. Thus, the mobile device can acquire the list before connection release or failure, as described. Furthermore, logical grouping 902 can also include an electrical component for specifying layer types in the frequency priority list to associate frequencies with types of access points operating over the frequencies 910. In this regard, the device receiving the list can discriminate for/against certain types of access points in monitoring frequencies for paging signals. Additionally, system 900 can include a memory 912 that retains instructions for executing functions associated with electrical components 904, 906, 908, and 910. While shown as being external to memory 912, it is to be understood that one or more of electrical components 904, 906, 908, and 910 can exist within memory 912.

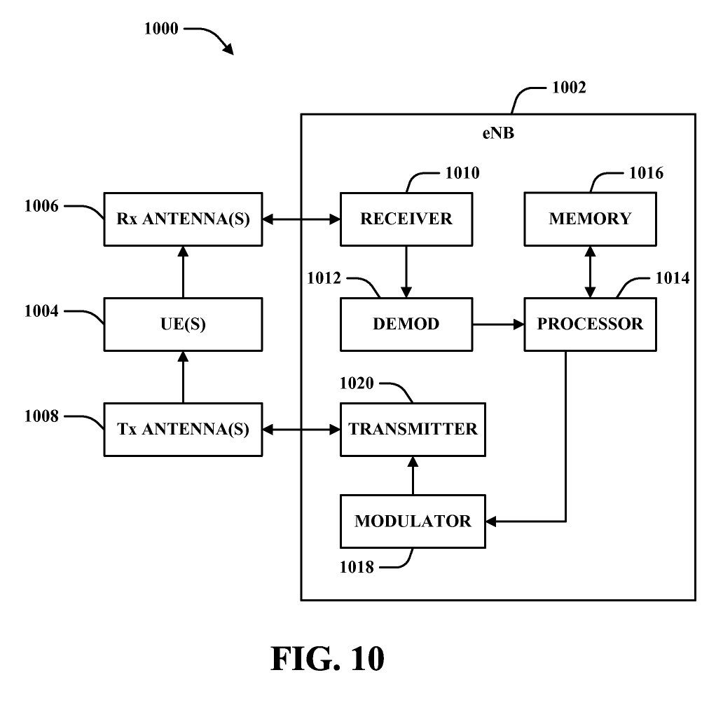

FIG. 10 is a block diagram of a system 1000 that can be utilized to implement various aspects of the functionality described herein. In one example, system 1000 includes a base station or eNB 1002. As illustrated, eNB 1002 can receive signal(s) from one or more UEs 1004 via one or more receive (Rx) antennas 1006 and transmit to the one or more UEs 1004 via one or more transmit (Tx) antennas 1008. Additionally, eNB 1002 can comprise a receiver 1010 that receives information from receive antenna(s) 1006. In one example, the receiver 1010 can be operatively associated with a demodulator (Demod) 1012 that demodulates received information. Demodulated symbols can then be analyzed by a processor 1014. Processor 1014 can be coupled to memory 1016, which can store information related to code clusters, access terminal assignments, lookup tables related thereto, unique scrambling sequences, and/or other suitable types of information. In one example, eNB 1002 can employ processor 1014 to perform methodologies 500, 600, 700, and/or other similar and appropriate methodologies. eNB 1002 can also include a modulator 1018 that can multiplex a signal for transmission by a transmitter 1020 through transmit antenna(s) 1008.

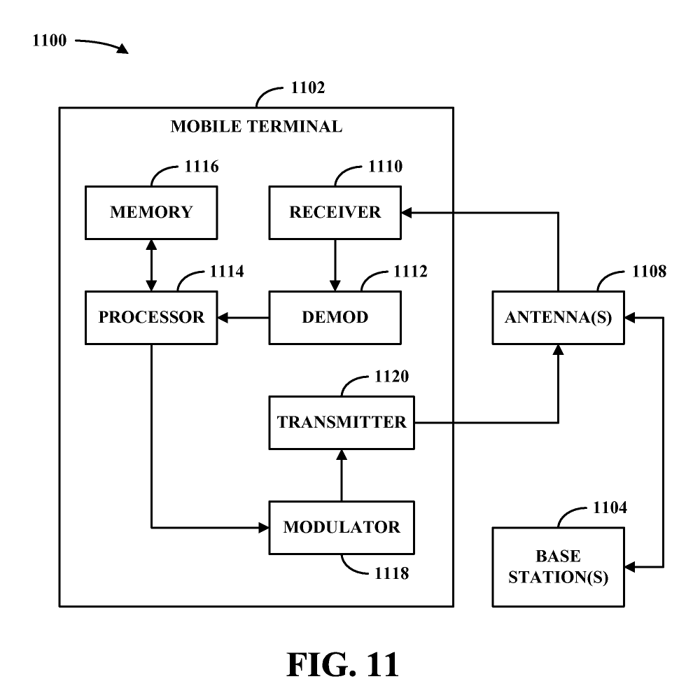

FIG. 11 is a block diagram of another system 1100 that can be utilized to implement various aspects of the functionality described herein. In one example, system 1100 includes a mobile terminal 1102. As illustrated, mobile terminal 1102 can receive signal(s) from one or more base stations 1104 and transmit to the one or more base stations 1104 via one or more antennas 1108. Additionally, mobile terminal 1102 can comprise a receiver 1110 that receives information from antenna(s) 1108. In one example, receiver 1110 can be operatively associated with a demodulator (Demod) 1112 that demodulates received information. Demodulated symbols can then be analyzed by a processor 1114. Processor 1114 can be coupled to memory 1116, which can store data and/or program codes related to mobile terminal 1102. Additionally, mobile terminal 1102 can employ processor 1114 to perform methodologies 500, 600, 700, and/or other similar and appropriate methodologies. Mobile terminal 1102 can also employ one or more components described in previous figures to effectuate the described functionality; in one example, the components can be implemented by the processor 1114. Mobile terminal 1102 can also include a modulator 1118 that can multiplex a signal for transmission by a transmitter 1120 through antenna(s) 1108.

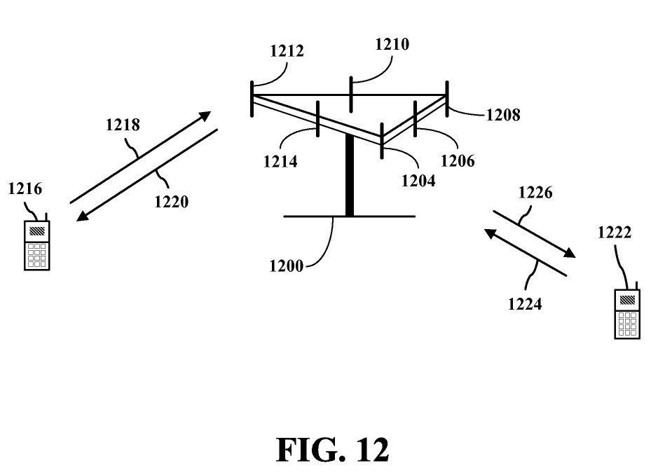

Referring now to FIG. 12, an illustration of a wireless multiple-access communication system is provided in accordance with various aspects. In one example, an access point 1200 (AP) includes multiple antenna groups. As illustrated in FIG. 12, one antenna group can include antennas 1204 and 1206, another can include antennas 1208 and 1210, and another can include antennas 1212 and 1214. While only two antennas are shown in FIG. 12 for each antenna group, it should be appreciated that more or fewer antennas may be utilized for each antenna group. In another example, an access terminal 1216 can be in communication with antennas 1212 and 1214, where antennas 1212 and 1214 transmit information to access terminal 1216 over forward link 1220 and receive information from access terminal 1216 over reverse link 1218. Additionally and/or alternatively, access terminal 1222 can be in communication with antennas 1206 and 1208, where antennas 1206 and 1208 transmit information to access terminal 1222 over forward link 1226 and receive information from access terminal 1222 over reverse link 1224. In a frequency division duplex system, communication links 1218, 1220, 1224 and 1226 can use different frequency for communication. For example, forward link 1220 may use a different frequency then that used by reverse link 1218.

Each group of antennas and/or the area in which they are designed to communicate can be referred to as a sector of the access point. In accordance with one aspect, antenna groups can be designed to communicate to access terminals in a sector of areas covered by access point 1200. In communication over forward links 1220 and 1226, the transmitting antennas of access point 1200 can utilize beamforming in order to improve the signal-to-noise ratio of forward links for the different access terminals 1216 and 1222. Also, an access point using beamforming to transmit to access terminals scattered randomly through its coverage causes less interference to access terminals in neighboring cells than an access point transmitting through a single antenna to all its access terminals.

An access point, e.g., access point 1200, can be a fixed station used for communicating with terminals and can also be referred to as a base station, an eNB, an access network, and/or other suitable terminology. In addition, an access terminal, e.g., an access terminal 1216 or 1222, can also be referred to as a mobile terminal, user equipment, a wireless communication device, a terminal, a wireless terminal, and/or other appropriate terminology.

In some aspects the teachings herein may be employed in a network that includes macro scale coverage (e.g., a large area cellular network such as a 3G networks, typically referred to as a macro cell network) and smaller scale coverage (e.g., a residence-based or building-based network environment). As an access terminal (AT) moves through such a network, the access terminal may be served in certain locations by access nodes (ANs) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

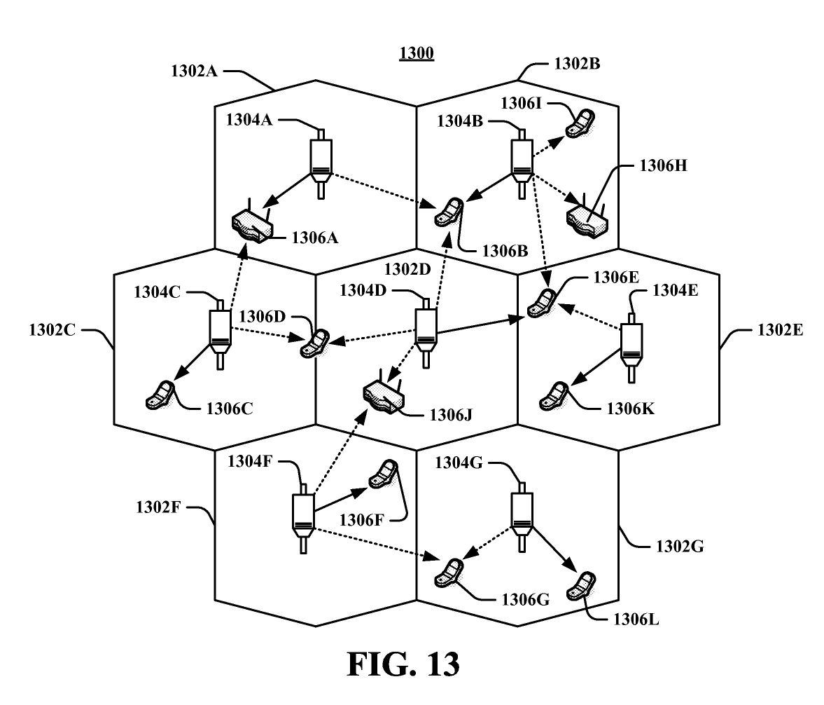

FIG. 13 illustrates a wireless communication system 1300, configured to support a number of users, in which the teachings herein may be implemented. The system 1300 provides communication for multiple cells 1302, such as, for example, macro cells 1302A-1302G, with each cell being serviced by a corresponding access node 1304 (e.g., access nodes 1304A-1304G). As shown in FIG. 13, access terminals 1306 (e.g., access terminals 1306A-1306L) may be dispersed at various locations throughout the system over time. Each access terminal 1306 may communicate with one or more access nodes 1304 on a forward link (FL) and/or a reverse link (RL) at a given moment, depending upon whether the access terminal 1306 is active and whether it is in soft handoff, for example. The wireless communication system 1300 may provide service over a large geographic region. For example, macro cells 1302A-1302G may cover a few blocks in a neighborhood.

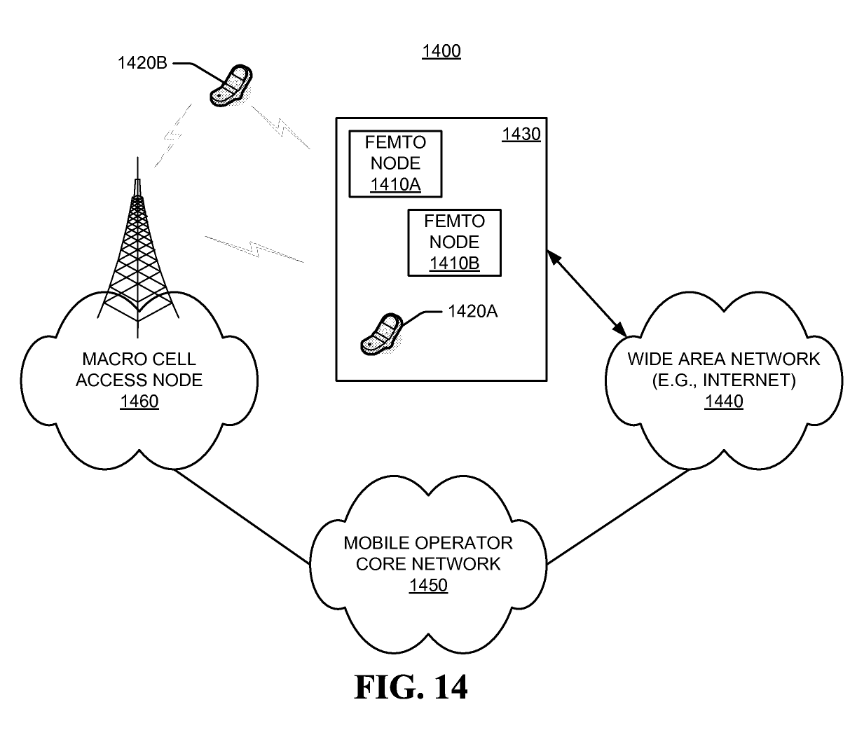

FIG. 14 illustrates an exemplary communication system 1400 where one or more femto nodes are deployed within a network environment. Specifically, the system 1400 includes multiple femto nodes 1410 (e.g., femto nodes 1410A and 1410B) installed in a relatively small scale network environment (e.g., in one or more user residences 1430). Each femto node 1410 may be coupled to a wide area network 1440 (e.g., the Internet) and a mobile operator core network 1450 via a DSL router, a cable modem, a wireless link, or other connectivity means (not shown). As will be discussed below, each femto node 1410 may be configured to serve associated access terminals 1420 (e.g., access terminal 1420A) and, optionally, alien access terminals 1420 (e.g., access terminal 1420B). In other words, access to femto nodes 1410 may be restricted whereby a given access terminal 1420 may be served by a set of designated (e.g., home) femto node(s) 1410 but may not be served by any non-designated femto nodes 1410 (e.g., a neighbor's femto node 1410).

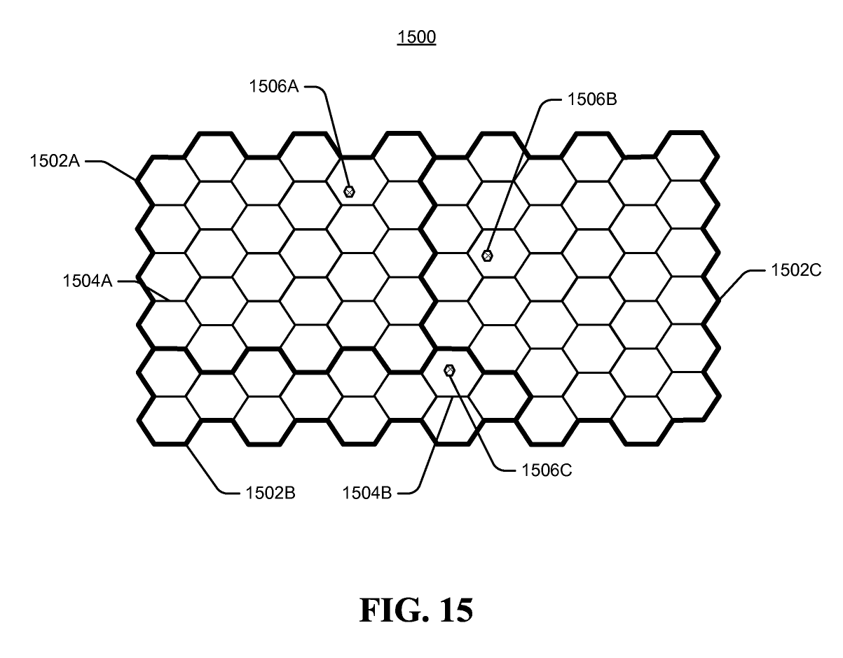

FIG. 15 illustrates an example of a coverage map 1500 where several tracking areas 1502 (or routing areas or location areas) are defined, each of which includes several macro coverage areas 1504. Here, areas of coverage associated with tracking areas 1502A, 1502B, and 1502C are delineated by the wide lines and the macro coverage areas 1504 are represented by the hexagons. The tracking areas 1502 also include femto coverage areas 1506. In this example, each of the femto coverage areas 1506 (e.g., femto coverage area 1506C) is depicted within a macro coverage area 1504 (e.g., macro coverage area 1504B). It should be appreciated, however, that a femto coverage area 1506 may not lie entirely within a macro coverage area 1504. In practice, a large number of femto coverage areas 1506 may be defined with a given tracking area 1502 or macro coverage area 1504. Also, one or more pico coverage areas (not shown) may be defined within a given tracking area 1502 or macro coverage area 1504.

Referring again to FIG. 14, the owner of a femto node 1410 may subscribe to mobile service, such as, for example, 3G mobile service, offered through the mobile operator core network 1450. In addition, an access terminal 1420 may be capable of operating both in macro environments and in smaller scale (e.g., residential) network environments. In other words, depending on the current location of the access terminal 1420, the access terminal 1420 may be served by an access node 1460 of the macro cell mobile network 1450 or by any one of a set of femto nodes 1410 (e.g., the femto nodes 1410A and 1410B that reside within a corresponding user residence 1430). For example, when a subscriber is outside his home, he is served by a standard macro access node (e.g., node 1460) and when the subscriber is at home, he is served by a femto node (e.g., node 1410A). Here, it should be appreciated that a femto node 1420 may be backward compatible with existing access terminals 1420.

A femto node 1410 may be deployed on a single frequency or, in the alternative, on multiple frequencies. Depending on the particular configuration, the single frequency or one or more of the multiple frequencies may overlap with one or more frequencies used by a macro node (e.g., node 1460).

In some aspects, an access terminal 1420 may be configured to connect to a preferred femto node (e.g., the home femto node of the access terminal 1420) whenever such connectivity is possible. For example, whenever the access terminal 1420 is within the user's residence 1430, it may be desired that the access terminal 1420 communicate only with the home femto node 1410.

In some aspects, if the access terminal 1420 operates within the macro cellular network 1450 but is not residing on its most preferred network (e.g., as defined in a preferred roaming list), the access terminal 1420 may continue to search for the most preferred network (e.g., the preferred femto node 1410) using a Better System Reselection (BSR), which may involve a periodic scanning of available systems to determine whether better systems are currently available, and subsequent efforts to associate with such preferred systems. With the acquisition entry, the access terminal 1420 may limit the search for specific band and channel. For example, the search for the most preferred system may be repeated periodically. Upon discovery of a preferred femto node 1410, the access terminal 1420 selects the femto node 1410 for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 1410 that reside within the corresponding user residence 1430). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access nodes (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that authorized to access the restricted femto node. A guest access terminal may refer to an access terminal with temporary access to the restricted femto node. An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a pico node may be restricted, a home pico node may be defined for a given access terminal, and so on.

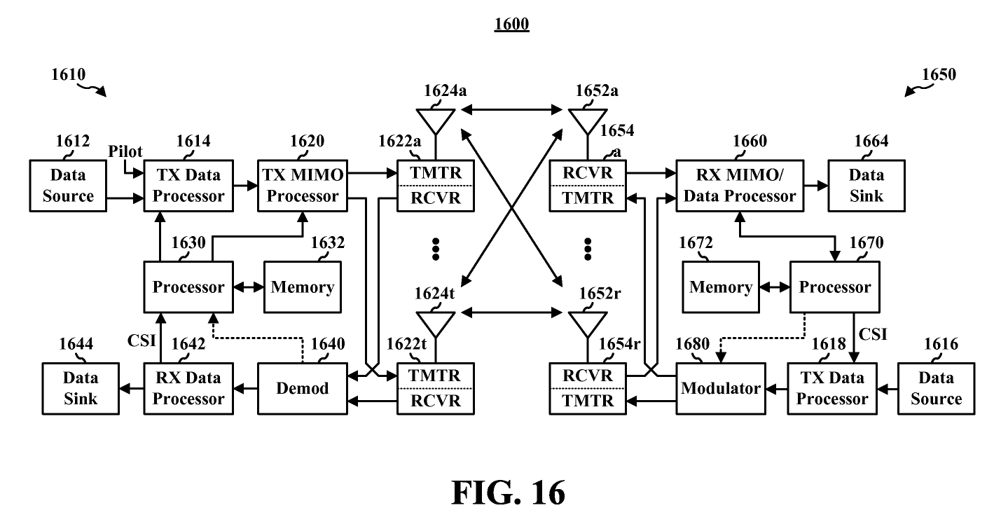

Referring now to FIG. 16, a block diagram illustrating an example wireless communication system 1600 in which various aspects described herein can function is provided. In one example, system 1600 is a multiple-input multiple-output (MIMO) system that includes a transmitter system 1610 and a receiver system 1650. It should be appreciated, however, that transmitter system 1610 and/or receiver system 1650 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 1610 and/or receiver system 1650 described herein could be utilized in connection with a single output to single input antenna system.

In accordance with one aspect, traffic data for a number of data streams are provided at transmitter system 1610 from a data source 1612 to a transmit (TX) data processor 1614. In one example, each data stream can then be transmitted via a respective transmit antenna 1624. Additionally, TX data processor 1614 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1650 to estimate channel response. Back at transmitter system 1610, the multiplexed pilot and coded data for each data stream can be modulated (i. e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1630.

Next, modulation symbols for all data streams can be provided to a TX processor 1620, which can further process the modulation symbols (e.g., for OFDM). TX MIMO processor 1620 can then provides N_{T} modulation symbol streams to N_{T} transceivers 1622a through 1622t. In one example, each transceiver 1622 can receive and process a respective symbol stream to provide one or more analog signals. Each transceiver 1622 can then further condition (e.g., amplify, filter, and upconvert) the analog signals to provide a modulated signal suitable for transmission over a MIMO channel. Accordingly, N_{T} modulated signals from transceivers 1622a through 1622t can then be transmitted from N_{T} antennas 1624a through 1624t, respectively.

In accordance with another aspect, the transmitted modulated signals can be received at receiver system 1650 by N_{R} antennas 1652a through 1652r. The received signal from each antenna 1652 can then be provided to respective transceivers 1654. In one example, each transceiver 1654 can condition (e.g., filter, amplify, and downconvert) a respective received signal, digitize the conditioned signal to provide samples, and then processes the samples to provide a corresponding “received” symbol stream. An RX MIMO/data processor 1660 can then receive and process the N_{R} received symbol streams from N_{R} transceivers 1654 based on a particular receiver processing technique to provide N_{T} “detected” symbol streams. In one example, each detected symbol stream can include symbols that are estimates of the modulation symbols transmitted for the corresponding data stream. RX processor 1660 can then process each symbol stream at least in part by demodulating, deinterleaving, and decoding each detected symbol stream to recover traffic data for a corresponding data stream. Thus, the processing by RX processor 1660 can be complementary to that performed by TX MIMO processor 1620 and TX data processor 1616 at transmitter system 1610. RX processor 1660 can additionally provide processed symbol streams to a data sink 1664.

In accordance with one aspect, the channel response estimate generated by RX processor 1660 can be used to perform space/time processing at the receiver, adjust power levels, change modulation rates or schemes, and/or other appropriate actions. Additionally, RX processor 1660 can further estimate channel characteristics such as, for example, signal-to-noise-and-interference ratios (SNRs) of the detected symbol streams. RX processor 1660 can then provide estimated channel characteristics to a processor 1670. In one example, RX processor 1660 and/or processor 1670 can further derive an estimate of the “operating” SNR for the system. Processor 1670 can then provide channel state information (CSI), which can comprise information regarding the communication link and/or the received data stream. This information can include, for example, the operating SNR. The CSI can then be processed by a TX data processor 1618, modulated by a modulator 1680, conditioned by transceivers 1654a through 1654r, and transmitted back to transmitter system 1610. In addition, a data source 1616 at receiver system 1650 can provide additional data to be processed by TX data processor 1618.

Back at transmitter system 1610, the modulated signals from receiver system 1650 can then be received by antennas 1624, conditioned by transceivers 1622, demodulated by a demodulator 1640, and processed by a RX data processor 1642 to recover the CSI reported by receiver system 1650. In one example, the reported CSI can then be provided to processor 1630 and used to determine data rates as well as coding and modulation schemes to be used for one or more data streams. The determined coding and modulation schemes can then be provided to transceivers 1622 for quantization and/or use in later transmissions to receiver system 1650. Additionally and/or alternatively, the reported CSI can be used by processor 1630 to generate various controls for TX data processor 1614 and TX MIMO processor 1620. In another example, CSI and/or other information processed by RX data processor 1642 can be provided to a data sink 1644.

In one example, processor 1630 at transmitter system 1610 and processor 1670 at receiver system 1650 direct operation at their respective systems. Additionally, memory 1632 at transmitter system 1610 and memory 1672 at receiver system 1650 can provide storage for program codes and data used by processors 1630 and 1670, respectively. Further, at receiver system 1650, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
establishing active mode communications with an access point;
receiving a frequency priority list from the access point during the active mode communications; and
storing the frequency priority list for subsequent use in determining one or more frequencies for receiving paging signals.

2. The method of claim 1, wherein the receiving the frequency priority list comprises receiving the frequency priority list from the access point in a radio resource control (RRC) layer message.

3. The method of claim 2, wherein the receiving the frequency priority list in the RRC layer message comprises receiving the frequency priority list from the access point in an RRC layer connection reconfiguration message.

4. The method of claim 1, wherein the receiving the frequency priority list comprises receiving the frequency priority list including a list of frequencies with associated priorities and layer types.

5. The method of claim 4, further comprising switching from the active mode communications to idle mode communications.

6. The method of claim 5, further comprising monitoring frequencies in the frequency priority list for one or more paging signals based at least in part on the associated priorities and layer types.

7. A wireless communications apparatus, comprising:
at least one processor configured to:
communicate with an access point in an active mode;
receive a frequency priority list from the access point while communicating in the active mode; and
store the frequency priority list for subsequent utilization in determining one or more frequencies for receiving paging signals; and
a memory coupled to the at least one processor.

8. The wireless communications apparatus of claim 7, wherein the at least one processor receives the frequency priority list in a radio resource control (RRC) layer message.

9. The wireless communications apparatus of claim 8, wherein the at least one processor receives the frequency priority list in an RRC reconfiguration message.

10. The wireless communications apparatus of claim 7, wherein the frequency priority list comprises a plurality of frequencies along with corresponding priorities and layer types.

11. The wireless communications apparatus of claim 10, wherein the at least one processor is further configured to switch from the active mode to an idle communication mode.

12. An apparatus, comprising:
means for communicating with an access point in an active mode; and
means for receiving a frequency priority list from the access point in the active mode and storing the list for subsequent utilization in an idle communication mode.

13. The apparatus of claim 12, wherein the means for receiving the frequency priority list from the access point receives the frequency priority list in a radio resource control (RRC) layer message from the access point.

14. The apparatus of claim 13, wherein the RRC layer message is an RRC connection reconfiguration message.

15. The apparatus of claim 12, wherein the frequency priority list comprises one or more frequencies and associated priorities and layer types.

16. The apparatus of claim 15, wherein the means for communicating with the access point switches from the active mode to the idle communication mode.

17. A computer program product, comprising:
a computer-readable medium comprising:
code for causing at least one computer to establish active mode communications with an access point;
code for causing the at least one computer to receive a frequency priority list from the access point during the active mode communications; and
code for causing the at least one computer to store the frequency priority list for subsequent use in determining one or more frequencies for receiving paging signals.

18. The computer program product of claim 17, wherein the code for causing the at least one computer to receive the frequency priority list receives the frequency priority list from the access point in a radio resource control (RRC) layer message.

19. The computer program product of claim 18, wherein the code for causing the at least one computer to receive the frequency priority list in the RRC message receives the frequency priority list in an RRC layer connection reconfiguration message.

20. The computer program product of claim 17, wherein the frequency priority list comprises a list of frequencies with associated priorities and a layer types.

21. An apparatus, comprising:
a communication mode component that communicates with an access point in an active mode; and
a frequency priority list component that receives a frequency priority list from the access point in the active mode and stores the list for subsequent utilization in an idle communication mode.

22. The apparatus of claim 21, wherein the frequency priority list component receives the frequency priority list in a radio resource control (RRC) layer message from the access point.

23. The apparatus of claim 22, wherein the RRC layer message is an RRC connection reconfiguration message.

24. The apparatus of claim 21, wherein the frequency priority list comprises one or more frequencies and associated priorities and layer types.

25. A method, comprising:
establishing a connection with a mobile device communicating in an active mode;
receiving a frequency priority list related to the mobile device; and
transmitting the frequency priority list to the mobile device in a connection reconfiguration message.

26. The method of claim 25, wherein the transmitting the frequency priority list comprises transmitting the frequency priority list to the mobile device in a radio resource control (RRC) layer message.

27. The method of claim 25, wherein the receiving the frequency priority list comprises receiving the frequency priority list from a mobility management entity (MME) or other core network component.

28. The method of claim 25, wherein the receiving the frequency priority list comprises generating the frequency priority list based at least in part on one or more parameters received from the mobile device, mobility management entity (MME), or other core network component.

29. The method of claim 25, wherein the receiving the frequency priority list comprises obtaining the frequency priority list from a configuration.

30. The method of claim 25, further comprising inserting layer types in the frequency priority list associating frequencies in the frequency priority list with types of access points operating over the frequencies.

31. The method of claim 30, further comprising receiving the layer types from a mobility management entity (MME) or other core network component.

32. A wireless communications apparatus, comprising:
at least one processor configured to:
communicate with a mobile device operating in an active mode;
obtain a frequency priority list related to the mobile device; and
transmit the frequency priority list to the mobile device in a connection reconfiguration message; and
a memory coupled to the at least one processor.

33. The wireless communications apparatus of claim 32, wherein the at least one processor transmits the frequency priority list to the mobile device in a radio resource control (RRC) layer message.

34. The wireless communications apparatus of claim 32, wherein the at least one processor obtains the frequency priority list related to the mobile device from a mobility management entity (MME) or other core network component.

35. The wireless communications apparatus of claim 32, wherein the at least one processor obtains the frequency priority list at least in part by generating the frequency priority list based at least in part on one or more parameters received from the mobile device, mobility management entity (MME), or other core network component.

36. The wireless communications apparatus of claim 32, wherein the at least one processor obtains the frequency priority list from a configuration.

37. An apparatus, comprising:
means for establishing active mode communication with a mobile device;
means for obtaining a frequency priority list related to the mobile device; and
means for transmitting the frequency priority list to the mobile device in a connection reconfiguration message.

38. The apparatus of claim 37, wherein the means for transmitting the frequency priority list transmits the frequency priority list to the mobile device in a radio resource control (RRC) layer message.

39. The apparatus of claim 37, wherein the means for obtaining the frequency priority list receives the frequency priority list from a mobility management entity (MME) or other core network component.

40. The apparatus of claim 37, wherein the means for obtaining the frequency priority list generates the list based at least in part one or more parameters received from the mobile device, a mobility management entity (MME), or other core network component.

41. The apparatus of claim 37, wherein the means for obtaining the frequency priority list receives the frequency priority list from a configuration.

42. A computer program product, comprising:
a computer-readable medium comprising:
code for causing at least one computer to establish a connection with a mobile device communicating in an active mode;
code for causing the at least one computer to receive a frequency priority list related to the mobile device; and
code for causing the at least one computer to transmit the frequency priority list to the mobile device in a connection reconfiguration message.

43. The computer program product of claim 42, wherein the connection reconfiguration message is a radio resource control (RRC) layer message.

44. The computer program product of claim 42, wherein the code for causing the at least one computer to receive the frequency priority list receives the frequency priority list from a mobility management entity (MME) or other core network component.

45. The computer program product of claim 42, wherein the code for causing the at least one computer to receive the frequency priority list generates the frequency priority list based at least in part on one or more parameters received from the mobile device, mobility management entity (MME), or other core network component.

46. The computer program product of claim 42, wherein the code for causing the at least one computer to receive the frequency priority list receives the frequency priority list from a configuration.

47. An apparatus, comprising:
a radio resource control (RRC) connection establishing component that initializes active mode communication with a mobile device;
a frequency priority list managing component that obtains a frequency priority list related to the mobile device; and
a frequency priority list provisioning component that transmits the frequency priority list to the mobile device in a connection reconfiguration message.

48. The apparatus of claim 47, wherein the frequency priority list provisioning component transmits the frequency priority list in a radio resource control (RRC) layer message.

49. The apparatus of claim 47, wherein the frequency priority list managing component receives the frequency priority list from a mobility management entity (MME) or other core network component.

50. The apparatus of claim 47, wherein the frequency priority list managing component generates the list based at least in part one or more parameters received from the mobile device, a mobility management entity (MME), or other core network component.
